(19) United States
(12) Patent Application Publication
(10) Pub. No.: US 2025/0101174 A1
(43) Pub. Date: Mar. 27, 2025

(54) METHOD FOR PRODUCING POLYETHYLENE GLYCOL COMPOUND

(71) Applicant: NOF CORPORATION, Tokyo (JP)

(72) Inventors: Honami KATAGIRI, Kawasaki-shi (JP); Atsushi Sato, Kawasaki-shi (JP)

(73) Assignee: NOF CORPORATION, Tokyo (JP)

(21) Appl. No.: 18/896,147

(22) Filed: Sep. 25, 2024

(30) Foreign Application Priority Data
Sep. 27, 2023 (JP) 2023-164135

(51) Int. Cl. C08G 65/333

(52) U.S. Cl. CPC C08G 65/33344

(57) ABSTRACT

A method for producing an activated polyethylene glycol compound having a carbamate bond between a polyethylene glycol moiety and a functional group capable of reacting with a bio-related substance or a precursor of the functional group, includes: reacting a polyethylene glycol raw material having a nitrophenyl group at a terminal thereof with an amine compound having the functional group capable of reacting with the bio-related substance or the precursor of the functional group in a solution containing an aprotic solvent to obtain a reaction mixture containing the activated polyethylene glycol compound and 4-nitrophenol; adding a basic aqueous solution having a pH of 10 or more and 14 or less to the reaction mixture to obtain a two-phase mixture; and separating an organic layer of the two-phase mixture from an aqueous layer of the two-phase mixture and recovering the activated polyethylene glycol compound from the organic layer.

### CROSS-REFERENCE TO RELATED APPLICATION

This application is based on and claims priority under 35 USC 119 from Japanese Patent Application No. 2023-164135 filed on Sep. 27, 2023.

### TECHNICAL FIELD

The present invention relates to a method for producing a polyethylene glycol compound suitable for medical use.

### BACKGROUND ART

When a pharmaceutical that uses bio-related substances such as hormones, cytokines, and enzymes is administered into a general living body, it is promptly excreted from the living body through glomerular filtration in the kidneys and uptake by macrophages in the liver or spleen. Therefore, a half-life in blood of the bio-related substance is short, and it is often difficult to obtain a sufficient pharmacological effect.

As a means for solving this problem, activated polyethylene glycol is widely used. In the activated polyethylene glycol, a terminal of polyethylene glycol is substituted with a reactive functional group to allow reaction with the bio-related substance, and the bio-related substance to which the activated polyethylene glycol is bonded can have an extended half-life in blood by increasing a molecular weight thereof and forming a hydration layer. It is also known that by modifying the bio-related substance with the activated polyethylene glycol (PEGylation), it is possible to obtain effects such as reducing toxicity and antigenicity of the bio-related substance and improving an aggregation property thereof.

The activated polyethylene glycol generally contains a linker, which is not derived from a polyethylene glycol moiety, between the polyethylene glycol moiety and a terminal functional group. Chain length, steric hindrance and bond of this linker may affect stability of an activated polyethylene glycol compound itself and stability of a modified product after modification with a bio-related substance. For example, ester bond and carbonate bond are susceptible to hydrolysis. Therefore, when these bonds are used as the linker, the linker moiety is gradually hydrolyzed by a moisture content in an aqueous solution or in the system, and the activated polyethylene glycol compound or the modified product thereof is cut off, which is undesirable. On the other hand, activated polyethylene glycol compounds using carbamate bonds as linkers are less susceptible to hydrolysis. Therefore, activated polyethylene glycol compounds using carbamate bonds are known as highly stable PEGylation reagents, and are also used in Cimzia (registered trademark), a therapeutic drug for rheumatoid arthritis.

Such an activated polyethylene glycol compound having a carbamate bond can be obtained by reacting a polyethylene glycol compound having an active carbonate group such as 4-nitrophenyl carbonate with an amine compound, or by reacting a polyethylene glycol compound having an amino group with an active carbonate compound. These reactions produce 4-nitrophenol as a by-product along with a desired product. Even if a small amount of 4-nitrophenol remains in the activated polyethylene glycol compound, the activated polyethylene glycol compound, which is originally white to off-white, may turn yellow in appearance. For this reason, it is desirable to reduce the amount of 4-nitrophenol.

In general, when removing low molecular weight compounds as impurities from an amphiphilic polymer compound such as polyethylene glycol, purification methods such as adsorption and crystallization can be used.

In Patent Literature 1, a white powder is obtained by using a solvent in an amount 200 times or more by volume of an activated polyethylene glycol compound obtained by reacting a polyethylene glycol compound having an active carbonate group with an amine compound.

In Patent Literature 2, polyethylene glycol having an amino group is reacted with 4-nitrophenyl carbonate, and purified by adsorbing a by-product 4-nitrophenol as an impurity using a resin, to obtain a pale yellow solid.

### PATENT LITERATURES

Patent Literature 1: JP2008-545371A
Patent Literature 2: JP2020-7562A

### SUMMARY OF INVENTION

However, when the production method in Patent Literature 1 is intended for large-scale production, the amount of solvent used is large, and an amount that can be produced at one time is limited due to equipment restrictions, making it unsuitable for industrial production.

Moreover, the product obtained by the production method in Patent Literature 2 is pale yellow in color. Since even a trace amount of 4-nitrophenol discolors the product, the method described in Patent Literature 2 cannot remove 4-nitrophenol to a level that does not cause discolor. On the other hand, it is also considered to remove 4-nitrophenol to a level that does not cause discolor by repeating the adsorption. However, in this case, the activated PEG is also adsorbed together with 4-nitrophenol, resulting in a low yield. Furthermore, a large amount of adsorbent is ultimately produced as waste, which is problematic from an industrial standpoint.

In view of the above problems, an object of the present invention is to provide an industrially practicable method for producing an activated polyethylene glycol compound, which can purify the activated polyethylene glycol compound with high efficiency and high purity.

Aspects of the present invention provides are as follows:

(1) A method for producing an activated polyethylene glycol compound having a carbamate bond between a polyethylene glycol moiety and a functional group capable of reacting with a bio-related substance or a precursor of the functional group, the method comprising:
reacting a polyethylene glycol raw material having a nitrophenyl group at a terminal of the polyethylene glycol raw material with an amine compound having the functional group capable of reacting with the bio-related substance or the precursor of the functional group in a solution containing an aprotic solvent to obtain a reaction mixture containing the activated polyethylene glycol compound and 4-nitrophenol;
adding a basic aqueous solution having a pH of 10 or more and 14 or less to the reaction mixture to obtain a two-phase mixture; and
separating an organic layer of the two-phase mixture from an aqueous layer of the two-phase mixture and recovering the activated polyethylene glycol compound from the organic layer.

(2) The method for producing an activated polyethylene glycol compound according to (1), wherein
the activated polyethylene glycol compound has the carbamate bond between the precursor and the polyethylene glycol moiety, and
the precursor is a protecting group for the functional group.

(3) The method for producing an activated polyethylene glycol compound according to (2), further comprising:
deprotecting the protecting group after the reacting of the polyethylene glycol raw material with the amine compound and before the adding of the basic aqueous solution.

(4) The method for producing an activated polyethylene glycol compound (3), wherein
in the deprotecting, a deprotection reagent containing an organic base having an amino group is added to the reaction mixture containing the activated polyethylene glycol compound and 4-nitrophenol.

(5) The method for producing an activated polyethylene glycol compound according to any one of (1) to (4), wherein
the activated polyethylene glycol compound is represented by the following formula (1),

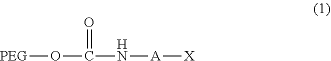

wherein
PEG represents the polyethylene glycol moiety,
X represents the functional group capable of reacting with the bio-related substance or the precursor of the functional group, and
A represents a divalent linker that bonds the functional group or the precursor to a carbamate group.

The present inventors have conducted diligent studies for solving the above problems, and as a result, have focused on and specifically investigated a method for efficiently producing a polyethylene glycol compound with high purity by separating an activated polyethylene glycol compound and 4-nitrophenol by extraction. In general, a necessary condition for extraction is that a solubility of a desired product and a solubility of an impurity in water or an organic solvent are significantly different. Polyethylene glycol, which is amphiphilic, has an extremely unique property of being capable of being selectively distributed into either an organic layer or an aqueous layer during two-phase system extraction by using appropriate conditions. Therefore, when the impurity is a water-soluble compound, purification is possible by distributing the polyethylene glycol into the organic layer and the impurity into the aqueous layer. However, although 4-nitrophenol has a water-octanol coefficient of 1.91, which indicates that 4-nitrophenol is somewhat hydrophobic, 4-nitrophenol has a solubility in water of 1.6 g/100 mL, and is distributed into both the organic layer and the aqueous layer. Therefore, even if the polyethylene glycol is distributed to the aqueous layer and 4-nitrophenol is extracted with an organic solvent, it is assumed that efficient purification would be difficult.

However, the present inventors have discovered a method for producing an activated polyethylene glycol compound by adding a basic aqueous solution having a pH of 10 or more and 14 or less to a reaction mixture containing an activated polyethylene glycol compound and 4-nitrophenol to form a two-phase mixture, and separating the mixture into an organic layer containing the activated polyethylene glycol compound and an aqueous layer containing 4-nitrophenol. This invention is characterized in that the reaction mixture is washed and distributed with the basic aqueous solution having a pH of 10 or more and 14 or less, and that the method does not require a large amount of adsorbent and can be performed in large-scale production, which is industrially suitable.

Therefore, the production method of the present invention is epoch-making in that it can be easily performed industrially, has excellent productivity, does not produce wastes such as adsorbents, and is capable of recovering a specific activated polyethylene glycol compound having a carbamate bond in high yield.

### DESCRIPTION OF EMBODIMENTS

### Activated Polyethylene Glycol Compound

An activated polyethylene glycol compound produced by a production method according to the present invention is an activated polyethylene glycol compound having a carbamate bond between a polyethylene glycol moiety and a functional group capable of reacting with a bio-related substance or a precursor of the functional group. The polyethylene glycol moiety may have a linear structure or a branched structure.

In a preferred embodiment, the activated polyethylene glycol compound is represented by the following Formula (1).

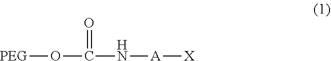

In Formula (1), PEG represents the polyethylene glycol moiety having a linear structure or a branched structure, and X represents the functional group capable of reacting with the bio-related substance or the precursor of the functional group. A represents a divalent linker bonding a carbamate group to X.

A molecular weight of the polyethylene glycol moiety in the activated polyethylene glycol compound is preferably 1,000 to 100,000 Daltons, more preferably 1,000 to 80,000 Daltons, and still more preferably 1,000 to 60,000 Daltons.

In the activated polyethylene glycol compound, the polyethylene glycol moiety having a branched structure is a polyethylene glycol chain which is branched into two or more chains, and the polyethylene glycol chain may have a plurality of branching points. A preferable example thereof is a polyethylene glycol chain branched into two or more chains and having a polyhydric alcohol such as glycerin as a branching point, as shown in the following Formula (2).

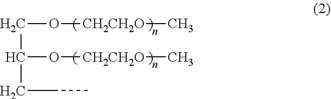

Here, in Formula (2), the molecular weight of the polyethylene glycol moiety (CH₂CH₂O) n is preferably 1,000 to 100,000 Daltons, more preferably 1,000 to 80,000 Daltons, and still more preferably 1,000 to 60,000 Daltons.

The “functional group capable of reacting with a bio-related substance or a precursor of the functional group” refers to a functional group or a precursor thereof that reacts with a functional group present in the bio-related substance, including protein drugs, polypeptides, enzymes, antibodies, antibody drugs, genes, nucleic acid compounds including oligonucleic acids, nucleic acid drugs, anticancer drugs, other drugs such as low molecular weight drugs, to form a covalent bond. Specific examples of this functional group or the precursor of the functional group include an amino group, an amino group protected with a phthalimidyl group, a thiol group, a formyl group, a formyl group protected with an acetal, a carboxyl group, a maleimidyl group, a substituted maleimidyl group, a p-nitrophenyl ester group, an N-hydroxysuccinimidyl ester group, an azido group, and an alkynyl group, and preferred examples thereof include an amino group, an amino group protected with a phthalimidyl group, a formyl group, a formyl group protected with an acetal, an azido group, and an alkynyl group.

The divalent linker that bonds the carbamate group to the functional group or the precursor X is preferably an alkylene group having 1 to 10 carbon atoms or —(CH₂CH₂O)ₙ—R—. Here, n is an integer, and is preferably 1 to 4,000, more preferably 1 to 3,000, and still more preferably 1 to 2,000. R represents an alkylene group having 1 to 10 carbon atoms.

### Method for Producing Activated Polyethylene Glycol Compound

The present invention provides a method for producing the activated polyethylene glycol compound, which includes the following Steps (1), (2) and (3). Each step will be described below.

### Regarding Step (1)

In Step (1), a polyethylene glycol raw material having a nitrophenyl group at a terminal thereof is reacted with an amine compound having the functional group capable of reacting with the bio-related substance or the precursor of the functional group in a solution containing an aprotic solvent to obtain a reaction mixture containing the activated polyethylene glycol compound and 4-nitrophenol.

The polyethylene glycol raw material having a nitrophenyl group at the terminal thereof is represented by the following Formula (3).

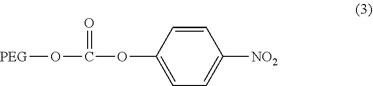

In Formula (3), PEG represents the polyethylene glycol moiety having a linear structure or a branched structure.

The polyethylene glycol moiety having a branched structure is a polyethylene glycol chain which is branched into two or more chains, and may have a plurality of branching points. A preferable example thereof is a polyethylene glycol chain branched into two or more chains and having a polyhydric alcohol such as glycerin as a branching point, as shown in the following Formula (4).

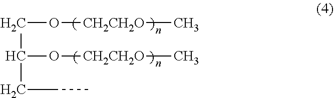

The polyethylene glycol moiety of the polyethylene glycol raw material is monodisperse polyethylene glycol or polydisperse polyethylene glycol. As described in the description of JP6638970B2, the monodisperse polyethylene glycol refers to polyethylene glycol characterized by having a purity of 90% or more for polyethylene glycol and a content of 2% or less for each impurity, and is polyethylene glycol of a single molecular weight without molecular weight distribution. The polydisperse polyethylene glycol refers to a polymer of ethylene glycol, and unlike the monodisperse polyethylene glycol, it is polyethylene glycol having a molecular weight distribution. The polydisperse polyethylene glycol in the present invention is a polymer having a molecular weight distribution of preferably 1.2 or less, more preferably 1.1 or less, and most preferably 1.03 or less. The polyethylene glycol in the present invention refers to a compound synthesized by a polymerization reaction of ethylene glycol or ethylene oxide.

A molecular weight of the polyethylene glycol moiety in the polyethylene glycol raw material is preferably 1,000 to 100,000 Daltons, more preferably 1,000 to 80,000 Daltons, and still more preferably 1,000 to 60,000 Daltons.

The “aprotic solvent” refers to a solvent that does not have a proton-donating property, and examples thereof include hydrocarbon solvents such as toluene, benzene, hexane, and heptane, and chlorine-containing hydrocarbon solvents such as chloroform and dichloromethane. From the viewpoint of a solubility of polyethylene glycol and a separation ability from water, toluene, chloroform and dichloromethane are particularly preferred. An amount of the aprotic solvent is 1 to 50 times, preferably 1 to 20 times, and more preferably 1 to 10 times a weight of the polyethylene glycol raw material.

The “amine compound having a functional group capable of reacting with the bio-related substance or a precursor of the functional group” refers to a compound having a functional group capable of reacting with the bio-related substance or a precursor of the functional group at one terminal and an amino group at the other terminal, and is preferably represented by the following Formula (5).

H₂N-A-X (5)

In Formula (5), the amino group (NH₂) moiety may be hydrochloride (NH₃⁺Cl⁻), in which case the reaction is performed by adding an amine reagent such as triethylamine. X represents a functional group capable of reacting with the bio-related substance or a precursor of the functional group. A represents a divalent linker bonding the amino group to X.

The “functional group capable of reacting with a bio-related substance or a precursor of the functional group” refers to a functional group or a precursor thereof that reacts with a functional group present in the bio-related substance, including protein drugs, polypeptides, enzymes, antibodies, antibody drugs, genes, nucleic acid compounds including oligonucleic acids, nucleic acid drugs, anticancer drugs, other drugs such as low molecular weight drugs, to form a covalent bond. Specific examples thereof include an amino group, an amino group protected with a phthalimidyl group, a thiol group, a formyl group, a formyl group protected with an acetal, a carboxyl group, a maleimidyl group, a substituted maleimidyl group, a p-nitrophenyl ester group, an N-hydroxysuccinimidyl ester group, an azido group, and an alkynyl group, and preferred examples thereof include an amino group, an amino group protected with a phthalimidyl group, a formyl group, a formyl group protected with an acetal, an azido group, and an alkynyl group.

The divalent linker A that bonds the amino group to the functional group or the precursor X is preferably an alkylene group having 1 to 10 carbon atoms or —(CH₂CH₂O)ₙ—R—. Here, n is an integer, and is preferably 1 to 4,000, more preferably 1 to 3,000, and still more preferably 1 to 2,000. R represents an alkylene group having 1 to 10 carbon atoms.

### Deprotection Step

When the precursor is a protecting group for the functional group, a deprotection step may be included between Step (1) and Step (2). The deprotection step is a step of deprotecting the protecting group of the activated polyethylene glycol compound using a deprotection reagent.

The type of the protecting group and the type of the deprotection reagent are not particularly limited and can be selected from various types depending on the type of the chemically reactive functional group to be protected, conditions used, and presence of other functional groups or protecting groups in molecules, and specific examples thereof can be found in many general textbooks (Greene's Protective Groups in Organic Synthesis Fifth edition, Peter GM Wuts). For example, examples of a protecting group for the amino group include tert-butoxycarbonyl, benzyloxycarbonyl, 9-fluorenylmethyloxycarbonyl, 2,2,2-trichloroethoxycarbonyl, allyloxycarbonyl, phthalimidyl, p-toluenesulfonyl, and 2-nitrobenzenesulfonyl groups, with the phthalimidyl group being preferred.

The term “deprotection reagent” refers to a reagent that deprotects the protecting group to convert the protecting group into a functional group that reacts with the bio-related substance. The “deprotection reagent” is, for example, an organic base having an amino group. The organic base having an amino group is not particularly limited as long as it is a low molecular weight amine compound having a primary amino group, and is preferably a polyamine compound having two or more primary amino groups. Specific examples thereof include ethylenediamine, trimethylenediamine, diethylenetriamine, tris(2-aminoethyl)amine, and triethylenetetramine, in which the ethylenediamine is particularly preferred.

### Regarding Step (2)

The “basic aqueous solution having a pH of 10 or more and 14 or less” refers to an aqueous solution containing a basic reagent and having a pH of 10 or more and 14 or less. Here, examples of the basic reagent include sodium hydroxide, potassium hydroxide, primary amines, secondary amines, and tertiary amines, preferably primary amines, secondary amines, and tertiary amines, more preferably compounds having a pKa of 7 to 11 and having 1 to 2 nitrogen atoms, still more preferably methylamine, ethylamine, ethylenediamine, dimethylamine, diethylamine, ethylpropylamine, triethylamine, and N,N-diisopropylethylamine, and most preferably ethylenediamine and diethylamine.

An amount of the basic reagent added to prepare the basic aqueous solution having a pH of 10 or more and 14 or less is preferably 0.1 to 30 equivalents, more preferably 0.3 to 20 equivalents, and particularly preferably 0.5 to 10 equivalents, relative to the activated polyethylene glycol compound. When the deprotection step is included between Step (1) and Step (2), and the basic reagent is used as the deprotection reagent in an amount in excess of an amount of a reagent consumed in a deprotection reaction, an amount of the basic reagent added in Step (2) may be reduced according to the excess amount. This is because the reaction mixture after the deprotection step contains the basic reagent that is not consumed in the deprotection reaction.

By adding the basic aqueous solution having a pH of 10 or more and 14 or less to the reaction mixture obtained in Step (1), a two-phase mixture of an organic phase mainly containing the aprotic solvent and an aqueous phase can be obtained. A weight ratio of the organic phase mainly containing the aprotic solvent to the aqueous phase is preferably 1:0.001 to 1:50, more preferably 1:0.005 to 1:30, and particularly preferably 1:0.01 to 1:10. Note that the aprotic solvent may be added to the reaction mixture obtained in Step (1) to achieve the above weight ratio. A combination of the organic phase mainly containing the aprotic solvent and the aqueous phase is not particularly limited, and is preferably a combination in which the organic phase mainly containing the aprotic solvent is toluene, chloroform or dichloromethane, and the aqueous phase is ethylenediamine, diethylamine or saline containing sodium hydroxide.

### Regarding Step (3)

In Step (3), the organic layer of the two-phase mixture is separated from the aqueous layer. In this process, the organic layer containing the activated polyethylene glycol compound, 4-nitrophenol, and the aprotic solvent carried over from Step (1) and an aqueous layer containing the basic aqueous solution having a pH of 10 to 14 added in Step (2) are stirred to transfer 4-nitrophenol to the aqueous layer, followed by layer separation and removal of the aqueous layer.

A time required for stirring or layer separation is not particularly limited, and is preferably 1 minute to 6 hours, and more preferably 10 minutes to 3 hours. A temperature during stirring and layer separation is not particularly limited, and is preferably 10° C. to 80° C. Step (3) of separating the organic layer from the aqueous layer can be repeatedly performed to improve purification efficiency, and therefore may be performed not only once but for a plurality of times.

Note that when performing Step (3), it is preferable to further include a washing step for removing a base component in the basic aqueous solution contained in the organic layer. The “washing step” referred to here is a step of adding 5% to 25% saline to the organic layer from which the aqueous layer is removed, stirring and separating layers, and then removing the 5% to 25% saline. The washing step may be performed not only once but for a plurality of times, and preferably 1 time to 2 times.

The expression “recovering the activated polyethylene glycol compound from the organic layer” means recovering the activated polyethylene glycol compound from the organic layer as a solid or liquid. Specifically, after the organic layer is separated from the aqueous layer, moisture contained in the organic layer is removed by distillation through a concentration operation. Then, after the moisture is distilled off, if any salt is precipitated, filtering is performed.

Note that when the aprotic solvent used in the organic layer is an aprotic solvent such as chloroform or dichloromethane in which the activated polyethylene glycol compound is highly soluble, the aprotic solvent is distilled off by a concentration operation.

When the obtained activated polyethylene glycol compound is a liquid, the solvent is entirely distilled off by a concentration operation to recover the liquid activated polyethylene glycol compound.

On the other hand, when the obtained activated polyethylene glycol compound is a solid and the aprotic solvent is not distilled off from the organic layer, crystallization is performed to obtain the solid activated polyethylene glycol compound. Furthermore, when the obtained activated polyethylene glycol compound is a solid and the aprotic solvent such as chloroform or dichloromethane is distilled off from the organic layer, toluene or ethyl acetate is added to the organic layer from which the aprotic solvent is distilled off, and then crystallization is performed to obtain the solid activated polyethylene glycol compound. Crystallization means adding the organic layer to a poor solvent for the polyethylene glycol compound, or adding the poor solvent to the organic layer.

Note that examples of the poor solvent for the activated polyethylene glycol compound include diethyl ether, methyl tert-butyl ether (MTBE), hexane, and heptane.

### EXAMPLES

### Example 1

A 50 mL three-neck round-bottom flask equipped with a Dimroth condenser, a thermometer, and a nitrogen inlet tube was charged with the polyethylene glycol raw material having a nitrophenyl group at the terminal thereof, which is represented by Formula (6) (Mw: 2,000, 2.0 g, 1.0 mmol), and toluene (8.0 g), and the mixture was dissolved at approximately 50° C. using a water bath with stirring under nitrogen. Thereafter, N-aminoethoxyphthalimide hydrochloride (1.0 g) and triethylamine (0.64 g) were added and reacted at approximately 50° C. for 4 hours to obtain the reaction mixture (Step (1)).

Then, the insoluble N-aminoethoxyphthalimide hydrochloride was removed by filtration. In this case, a filter was washed with toluene (7.4 g). Ethylenediamine monohydrate (0.47 g) was added to the filtrate, and reacted at approximately 50° C. for 2 hours to deprotect a phthalimide group (deprotection step).

Next, toluene (2.6 g) and 25 wt % saline (5.3 g) previously adjusted to pH 10 by adding ethylenediamine (0.07 g) were added to the reaction mixture after the deprotection step to obtain the two-phase mixture (Step (2)).

The two-phase mixture was stirred at approximately 75° C., then separated into different layers and the aqueous layer of the two-phase mixture was removed. To the remaining organic layer, 25 wt % saline (5.3 g) previously adjusted to pH 10 by adding ethylenediamine (0.07 g) was added to obtain the two-phase mixture, which was then stirred at approximately 75° C. and separated into different layers, and the organic layer of the two-phase mixture is separated from the aqueous layer, and the above operation was repeated 4 times. To the separated organic layer, 25 wt % saline (5.3 g) was added, and the mixture was stirred at approximately 75° C. and separated into different layers, and the 25 wt % saline was removed to separate the organic layer (washing step). Thereafter, the separated organic layer was concentrated under reduced pressure to distill off moisture, and toluene (6.0 g) was added to the organic layer after distilling off the moisture, followed by filtration.

The filtrate was added to hexane (12 g) and crystallized at 10° C., and then suction filtration was performed to obtain crystals. An operation of adding toluene (12 g) to the obtained crystals for dissolving at 40° C., and adding hexane (12 g) for crystallization at 10° C. was repeated, followed by drying under reduced pressure, to obtain crystals of the activated polyethylene glycol compound represented by Formula (7) (Step (3)).

The crystals of the activated polyethylene glycol compound were analyzed with an ultraviolet-visible spectrophotometer (hereinafter referred to as a “UV-Vis spectrophotometer”), and it was confirmed that a content of 4-nitrophenol was 11 ppm.

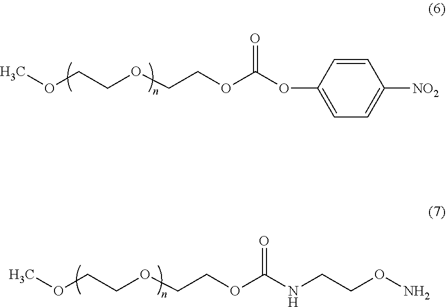

### Example 2

A 50 mL three-neck round-bottom flask equipped with an L-shaped tube, a thermometer, and a nitrogen inlet tube was charged with the polyethylene glycol raw material having a nitrophenyl group at the terminal thereof, which is represented by the above Formula (6) (Mw: 2,000, 2.0 g, 1.0 mmol), and dichloromethane (20 g), and the mixture was dissolved by stirring under nitrogen. Thereafter, N-aminoethoxyphthalimide hydrochloride (1.3 g) and triethylamine (0.64 g) were added and reacted at room temperature for 5 hours to obtain the reaction mixture (Step (1)).

Then, the insoluble N-aminoethoxyphthalimide hydrochloride was removed by filtration. Ethylenediamine monohydrate (0.47 g) was added to the filtrate, and reacted at room temperature for 2 hours to deprotect a phthalimide group (deprotection step).

To the obtained reaction mixture, 10 wt % sodium hydroxide-containing saline (pH 11, 8.0 g) was added to obtain the two-phase mixture (Step (2)). Specifically, the 10 wt % sodium hydroxide-containing saline (pH 11) was prepared as follows. A 10% saline was obtained by mixing 3 g of table salt and 27 g of distilled water. Next, 0.09 g of 400 g/L sodium hydroxide solution was added to the 10% saline to obtain the 10 wt % sodium hydroxide-containing saline (pH 11).

The two-phase mixture was stirred at approximately 25° C., then separated into different layers and the aqueous layer of the two-phase mixture was removed. To the remaining organic layer, 10 wt % sodium hydroxide-containing saline (pH 11, 8.0 g) was added to obtain the two-phase mixture, which was then stirred at approximately 25° C. and separated into different layers, and the organic layer of the two-phase mixture is separated from the aqueous layer, and the above operation was repeated 4 times. To the separated organic layer, 10 wt % saline (8.0 g) was added, and the mixture was stirred at approximately 25° C. and separated into different layers, and the 10 wt % saline was removed to separate the organic layer (washing step). Thereafter, the separated organic layer was concentrated under reduced pressure to distill off moisture and dichloromethane. Next, toluene (12 g) was added to the organic layer after distilling off the moisture and dichloromethane, followed by dissolving at approximately 40° C. and filtration. The filtrate was added to hexane (12 g) and crystallized at 10° C., and then suction filtration was performed to obtain crystals. An operation of adding toluene (12 g) to the obtained crystals for dissolving at 40° C., and adding hexane (12 g) for crystallization at 10° C. was repeated, followed by drying under reduced pressure, to obtain crystals of the activated polyethylene glycol compound represented by Formula (7) (Step (3)).

The crystals of the activated polyethylene glycol compound were analyzed with a UV-Vis spectrophotometer, and it was confirmed that a content of 4-nitrophenol was 413 ppm.

### Example 3

A 50 mL three-neck round-bottom flask equipped with an L-shaped tube, a thermometer, and a nitrogen inlet tube was charged with the polyethylene glycol raw material having a nitrophenyl group at the terminal thereof, which is represented by the above Formula (6) (Mw: 2,000, 2.0 g, 1.0 mmol), and chloroform (18 g), and the mixture was dissolved by stirring under nitrogen. Thereafter, N-aminoethoxyphthalimide hydrochloride (1.3 g) and triethylamine (0.64 g) were added and reacted at room temperature for 5 hours to obtain the reaction mixture (Step (1)).

Then, the insoluble N-aminoethoxyphthalimide hydrochloride was removed by filtration. Ethylenediamine monohydrate (0.47 g) was added to the filtrate, and reacted at room temperature for 2 hours to remove a phthalimide group (deprotection step).

Next, to the reaction mixture, 25 wt % saline (5.3 g) previously adjusted to pH 12 by adding diethylamine (0.07 g) was added to obtain the two-phase mixture (Step (2)).

The two-phase mixture was stirred at approximately 25° C., then separated into different layers and the aqueous layer of the two-phase mixture was removed. To the remaining organic layer, 25 wt % saline (5.3 g) previously adjusted to pH 12 by adding diethylamine (0.07 g) was added to obtain the two-phase mixture, which was then stirred at approximately 25° C. and separated into different layers, and the organic layer of the two-phase mixture is separated from the aqueous layer, and the above operation was repeated 4 times. To the separated organic layer, 25 wt % saline (5.3 g) was added, and the mixture was stirred at approximately 25° C. and separated into different layers, and the 25 wt % saline was removed to separate the organic layer (washing step). Thereafter, the separated organic layer was concentrated under reduced pressure to distill off moisture and chloroform. Next, toluene (12 g) was added to the organic layer after distilling off the moisture and chloroform, followed by dissolving at approximately 40° C. and filtration. The filtrate was added to hexane (12 g) and crystallized at 10° C., and then suction filtration was performed to obtain crystals. An operation of adding toluene (12 g) to the obtained crystals for dissolving at 40° C., and adding hexane (12 g) for crystallization at 10° C. was repeated, followed by drying under reduced pressure, to obtain crystals of the activated polyethylene glycol compound represented by the above Formula (7) (Step (3)).

The crystals of the activated polyethylene glycol compound were analyzed with a UV-Vis spectrophotometer, and it was confirmed that a content of 4-nitrophenol was 209 ppm.

### Example 4

A 50 mL three-neck round-bottom flask equipped with a Dimroth condenser, a thermometer, and a nitrogen inlet tube was charged with a branched polyethylene glycol raw material having a nitrophenyl group at a terminal thereof, which is represented by the following Formula (8) (Mw: 60,000, 2.0 g, 0.033 mmol), and toluene (8.0 g), and the mixture was dissolved at approximately 50° C. using a water bath with stirring under nitrogen. Thereafter, 3-aminopropionaldehyde diethyl acetal (14.7 mg) was added and reacted at approximately 50° C. for 2 hours to obtain the reaction mixture (Step (1)).

Next, toluene (10.0 g) and 25 wt % saline (5.3 g) previously adjusted to pH 12 by adding ethylenediamine (0.08 g) were added to the reaction mixture obtained in Step (1) to obtain the two-phase mixture (Step (2)).

The two-phase mixture was stirred at approximately 75° C., then separated into different layers and the aqueous layer of the two-phase mixture was removed. To the remaining organic layer, 25 wt % saline (5.3 g) previously adjusted to pH 12 by adding ethylenediamine (0.08 g) was added to obtain the two-phase mixture, which was then stirred at approximately 75° C. and separated into different layers, and the organic layer of the two-phase mixture is separated from the aqueous layer. To the separated organic layer, 25 wt % saline (5.3 g) was added, and the mixture was stirred at approximately 75° C. and separated into different layers, and the 25 wt % saline was removed to separate the organic layer (washing step). Thereafter, the separated organic layer was concentrated under reduced pressure to remove moisture, and then filtered. Hexane (12 g) was added to the filtrate to cause crystallization, and crystals were then obtained by suction filtration. An operation of adding ethyl acetate (20 g) to the obtained crystals for dissolving at 40° C., and then adding hexane (10 g) for crystallization was repeated, followed by drying under reduced pressure, to obtain crystals of the activated polyethylene glycol compound represented by the following Formula (9) (Step (3)).

The crystals of the activated polyethylene glycol compound were analyzed with a UV-Vis spectrophotometer, and it was confirmed that a content of 4-nitrophenol was 2 ppm.

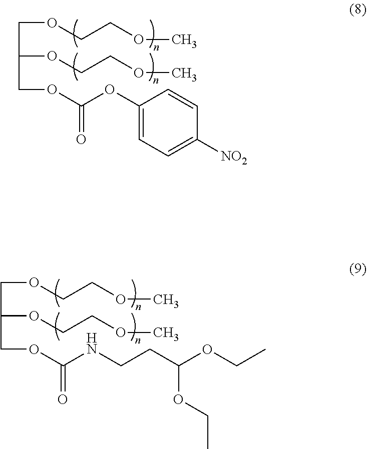

### Example 5

A 20 mL screw tube was charged with the polyethylene glycol raw material having a nitrophenyl group at the terminal thereof, which is represented by Formula (1) (Mw: 1,000, 0.5 g, 0.5 mmol), and dichloromethane (1.0 g), and the mixture was dissolved by stirring under nitrogen. Thereafter, Azido-dPEG-Amine (0.16 g) was added and reacted at room temperature for 3 hours to obtain the reaction mixture (Step (1)).

Next, to the reaction mixture, 25 wt % saline (2.5 g) previously adjusted to pH 12 by adding ethylenediamine (0.04 g) was added to obtain the two-phase mixture (Step (2)).

The two-phase mixture was stirred at approximately 25° C., then separated into different layers and the aqueous layer of the two-phase mixture was removed. To the remaining organic layer, 25 wt % saline (2.5 g) previously adjusted to pH 12 by adding ethylenediamine (0.04 g) was added to obtain the two-phase mixture, which was then stirred at approximately 25° C. and separated into different layers, and the organic layer of the two-phase mixture is separated from the aqueous layer, and the above operation was repeated 4 times. To the separated organic layer, 25 wt % saline (2.5 g) was added, and the mixture was stirred at approximately 25° C. and separated into different layers, and the 25 wt % saline was removed to separate the organic layer (washing step). Thereafter, the separated organic layer was concentrated under reduced pressure to distill off moisture and dichloromethane. Next, toluene (6 g) was added to the organic layer after distilling off the moisture and dichloromethane, followed by dissolving at approximately 40° C. and filtration. The filtrate was added to hexane (6 g) and crystallized at 10° C., and then suction filtration was performed to obtain crystals. An operation of adding toluene (6 g) to the obtained crystals for dissolving at 40° C., and adding hexane (6 g) for crystallization at 10° C. was repeated, followed by drying under reduced pressure, to obtain crystals of the activated polyethylene glycol compound represented by the following Formula (10) (Step (3)).

The crystals of the activated polyethylene glycol compound were analyzed with a UV-Vis spectrophotometer, and it was confirmed that a content of 4-nitrophenol was 233 ppm.

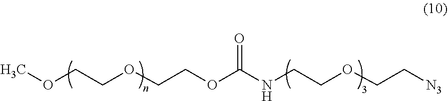

### Comparative Example 1

A 50 mL three-neck round-bottom flask equipped with a Dimroth condenser, a thermometer, and a nitrogen inlet tube was charged with the polyethylene glycol raw material having a nitrophenyl group at the terminal thereof, which is represented by the above Formula (6) (Mw: 2,000, 2.0 g, 1.0 mmol), and toluene (8.0 g), and the mixture was dissolved at approximately 50° C. using a water bath with stirring under nitrogen. Thereafter, N-aminoethoxyphthalimide hydrochloride (1.0 g) and triethylamine (0.64 g) were added and reacted at approximately 50° C. for 4 hours to obtain the reaction mixture (Step (1)).

Then, the insoluble N-aminoethoxyphthalimide hydrochloride was removed by filtration. In this case, a filter was washed with toluene (7.4 g). Ethylenediamine monohydrate (0.47 g) was added to the filtrate, and reacted at approximately 50° C. for 2 hours to deprotect a phthalimide group (deprotection step).

Then, toluene (2.6 g) and 20 wt % saline (5.3 g) were added to the reaction mixture after the deprotection step to obtain the two-phase mixture.

The two-phase mixture was stirred at approximately 75° C., then separated into different layers and the aqueous layer of the two-phase mixture was removed. To the remaining organic layer, 20 wt % saline (5.3 g) was added to obtain the two-phase mixture, which was then stirred at approximately 75° C. and separated into different layers, and the organic layer of the two-phase mixture is separated from the aqueous layer, and the above operation was repeated 5 times. The separated organic layer was concentrated under reduced pressure to distill off moisture. Next, toluene (6.0 g) was added to the organic layer after distilling off the moisture, followed by filtration. The filtrate was added to hexane (12 g) and crystallized at 10° C., and then suction filtration was performed to obtain crystals. An operation of adding toluene (12 g) to the obtained crystals for dissolving at 40° C., and adding hexane (12 g) for crystallization at 10° C. was repeated, followed by drying under reduced pressure, to obtain crystals of the activated polyethylene glycol compound represented by the above Formula (7).

The crystals of the activated polyethylene glycol compound were analyzed with a UV-Vis spectrophotometer, and it was confirmed that a content of 4-nitrophenol was 755 ppm.

Results of Examples 1 to 5 and Comparative Example 1 are shown in Table 1. These results show that, as compared Comparative Example 1, Examples 1 to 5 were able to remove 4-nitrophenol more effectively. Accordingly, the production method according to the present invention can be easily performed industrially, has excellent productivity, and makes it possible to recover a specific activated polyethylene glycol compound in high yield without generating waste materials such as adsorbents.

TABLE 1

| | Comparative | | | | | |
|---|---|---|---|---|---|---|
| | Example 1 | Example 1 | Example 2 | Example 3 | Example 4 | Example 5 |
| Functional | Amino group | Amino group | Amino group | Amino group | Acetal group | Azido group |
| group reactive | | | | | | |
| with bio-related | | | | | | |
| substance | | | | | | |
| Molecular | 2,000 | 2,000 | 2,000 | 2,000 | 60,000 | 1,000 |
| weight of | | | | | | |
| polyethylene | | | | | | |
| glycol moiety | | | | | | |
| Aprotic solvent | Toluene | Toluene | Dichloromethane | Chloroform | Toluene | Dichloromethane |
| (Step (1)) | | | | | | |
| Basic reagent | — | Ethylenediamine | Sodium | Diethylamine | Ethylenediamine | Ethylenediamine |
| in basic | | | hydroxide | | | |
| aqueous | | | | | | |
| solution | | | | | | |
| (Step (2)) | | | | | | |
| pH of basic | (Saline) 5 | 10 | 11 | 12 | 12 | 12 |
| aqueous | | | | | | |
| solutions | | | | | | |
| (Step (2)) | | | | | | |
| 4-Nitrophenol | 755 | 11 | 413 | 209 | 2 | 233 |
| content (ppm) | | | | | | |
| in desired | | | | | | |
| product | | | | | | |

What is claimed is:

1. A method for producing an activated polyethylene glycol compound having a carbamate bond between a polyethylene glycol moiety and a functional group capable of reacting with a bio-related substance or a precursor of the functional group, the method comprising:
reacting a polyethylene glycol raw material having a nitrophenyl group at a terminal of the polyethylene glycol raw material with an amine compound having the functional group capable of reacting with the bio-related substance or the precursor of the functional group in a solution containing an aprotic solvent to obtain a reaction mixture containing the activated polyethylene glycol compound and 4-nitrophenol;
adding a basic aqueous solution having a pH of 10 or more and 14 or less to the reaction mixture to obtain a two-phase mixture; and
separating an organic layer of the two-phase mixture from an aqueous layer of the two-phase mixture and recovering the activated polyethylene glycol compound from the organic layer.

2. The method for producing an activated polyethylene glycol compound according to claim 1, wherein
the activated polyethylene glycol compound has the carbamate bond between the precursor and the polyethylene glycol moiety, and
the precursor is a protecting group for the functional group.

3. The method for producing an activated polyethylene glycol compound according to claim 2, further comprising:
deprotecting the protecting group after the reacting of the polyethylene glycol raw material with the amine compound and before the adding of the basic aqueous solution.

4. The method for producing an activated polyethylene glycol compound according to claim 3, wherein
in the deprotecting, a deprotection reagent containing an organic base having an amino group is added to the reaction mixture containing the activated polyethylene glycol compound and 4-nitrophenol.

5. The method for producing an activated polyethylene glycol compound according to claim 1, wherein
the activated polyethylene glycol compound is represented by the following formula (1), 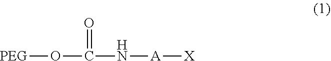
wherein
PEG represents the polyethylene glycol moiety,
X represents the functional group capable of reacting with the bio-related substance or the precursor of the functional group, and
A represents a divalent linker that bonds the functional group or the precursor to a carbamate group.

6. The method for producing an activated polyethylene glycol compound according to claim 2, wherein
the activated polyethylene glycol compound is represented by the following formula (1), 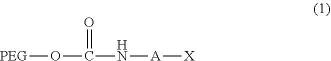
wherein
PEG represents the polyethylene glycol moiety,
X represents the functional group capable of reacting with the bio-related substance or the precursor of the functional group, and
A represents a divalent linker that bonds the functional group or the precursor to a carbamate group.

7. The method for producing an activated polyethylene glycol compound according to claim 3, wherein
the activated polyethylene glycol compound is represented by the following formula (1), 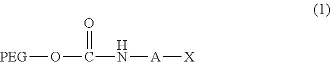
wherein
PEG represents the polyethylene glycol moiety,
X represents the functional group capable of reacting with the bio-related substance or the precursor of the functional group, and
A represents a divalent linker that bonds the functional group or the precursor to a carbamate group.

8. The method for producing an activated polyethylene glycol compound according to claim 4, wherein
the activated polyethylene glycol compound is represented by the following formula (1), 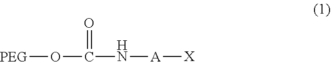
wherein
PEG represents the polyethylene glycol moiety,
X represents the functional group capable of reacting with the bio-related substance or the precursor of the functional group, and
A represents a divalent linker that bonds the functional group or the precursor to a carbamate group.
